(19) United States
(12) Patent Application Publication
(10) Pub. No.: US 2008/0250260 A1
(43) Pub. Date: Oct. 9, 2008

(54) INFORMATION PROCESSING APPARATUS, SCHEDULER, AND SCHEDULE CONTROL METHOD OF INFORMATION PROCESSING APPARATUS

(75) Inventor: Haruo Tomita, Iruma-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/047,802

(22) Filed: Mar. 13, 2008

(30) Foreign Application Priority Data
Apr. 6, 2007 (JP) 2007-100673

(51) Int. Cl. G06F 1/32; G06F 9/50; G06F 11/30

(52) U.S. Cl. 713/324; 713/320; 713/340; 718/104

(57) ABSTRACT

According to one embodiment, an information processing apparatus includes a CPU including a plurality of instruction processors, a monitoring unit which monitors an operating power supplying environment, and a power saving unit which controls the number of operating instruction processors provided in the CPU in accordance with the operating power supplying environment obtained by the monitoring with the monitoring unit.

### CROSS-REFERENCE TO RELATED APPLICATIONS

This application is based upon and claims the benefit of priority from Japanese Patent Application No. 2007-100673, filed Apr. 6, 2007, the entire contents of which are incorporated herein by reference.

### BACKGROUND

1. Field

One embodiment of the present invention relates to a schedule control technique suitably applied to an information processing apparatus such as a personal computer which is equipped with a CPU including a plurality of instruction processors (cores) referred to as, for example, a multicore CPU.

2. Description of the Related Art

In recent years, easily portable information processing apparatuses operable by batteries such as notebook type personal computers have been in wide use. As wireless communication environments have recently been developed, carrying this kind of information processing apparatus enables a person to acquire the latest data and execute tasks even when he is out or moving.

Functions expected to be installed in such a kind of information processing apparatus tend to be enhanced, such as a function to receive and view television broadcasts, for example, in an encrypted manner. In order to adapt to this function enhancement, features are contrived day by day to improve the processing performance of this kind of information processing apparatus. For example, a multiprocessor system is provided with a plurality of CPUs (processors) to enable various kinds of high-level processing to be executed in a short time. On the contrary, this kind of information processing apparatus is assumed to be used when one is out or moving, and therefore has a significantly critical problem in how to ensure a continuous usable time during battery operation, that is, how to save power. Under such circumstances, various proposals have heretofore been made to save power in the multiprocessor system (e.g., refer to Jpn. Pat. Appln. KOKAI Publication No. 2004-252937).

In the meantime, a new type of CPU referred to as, for example, a multicore CPU including a plurality of instruction processors (cores) has been recently developed. This enables the multiprocessor system to be realized by one CPU. Thus, there has been a strong request for a new power saving control system which considers the characteristics of the multicore CPU “including a plurality of instruction cores”, in connection with an information processing apparatus which is equipped with one multicore CPU rather than a plurality of CPUs to realize a multiprocessor system.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a hardware configuration of an information processing apparatus (personal computer) according to an embodiment of the invention;

FIG. 2 is an exemplary diagram illustrating a setting screen presented by a power saving control utility operating on the computer of the embodiment;

FIG. 3 is an exemplary diagram showing a configuration of a scheduling queue managed by a scheduler operating on the computer of the embodiment;

FIG. 4 is an exemplary flowchart showing a basic procedure of power saving control executed by the computer of the embodiment;

FIG. 5 is an exemplary flowchart showing a detailed procedure of processing for switching a core to an idle state during the power saving control executed by the computer of the embodiment; and

FIG. 6 is an exemplary flowchart showing a detailed procedure of processing for restoring a core from a stopped state or the idle state during the power saving control executed by the computer of the embodiment.

### DETAILED DESCRIPTION

Various embodiments according to the invention will be described hereinafter with reference to the accompanying drawings. In general, according to one embodiment of the invention, an information processing apparatus includes a CPU including a plurality of instruction processors, a monitoring unit which monitors an operating power supplying environment, and a power saving unit which controls the number of operating instruction processors provided in the CPU in accordance with the operating power supplying environment obtained by the monitoring with the monitoring unit.

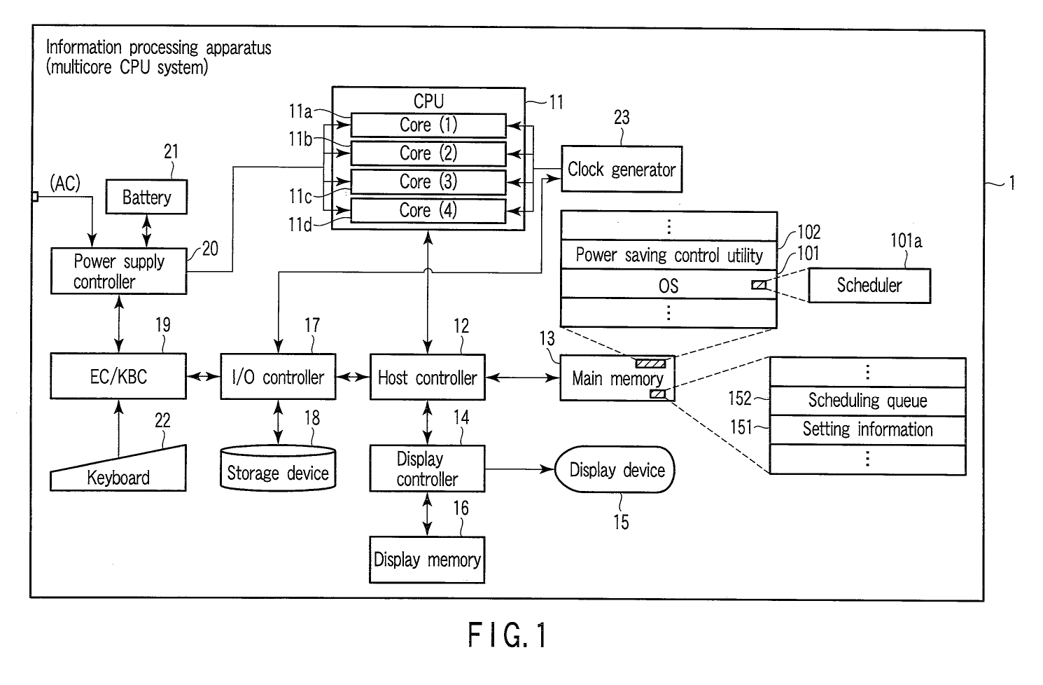

FIG. 1 shows an example of the hardware configuration of an information processing apparatus according to the embodiment. This information processing apparatus is realized as, for example, an easily portable notebook type personal computer 1 operable by a battery.

As shown in FIG. 1, the computer 1 is a multicore CPU equipped system equipped with a CPU 11 incorporating four instruction processors (cores); a core (1) 11a, a core (2) 11b, a core (3) 11c and a core (4) 11d. In addition, a power saving control technique of the invention described in the embodiment is also applicable to a dual core CPU equipped system equipped with a so-called dual core CPU incorporating two cores or to any type of multicore CPU equipped systems equipped with a plurality of cores except for four cores.

Furthermore, as shown in FIG. 1, the computer 1 comprises the CPU 11, a host controller 12, a main memory 13, a display controller 14, a display 15, a display memory 16, an I/O controller 17, a storage 18, an embedded controller/keyboard controller (EC/KBC) 19, a power supply controller 20, a battery 21, a keyboard 22, clock generator 23, etc.

The CPU 11 is a processor for integrally managing and controlling the operations of the respective units in the computer 1, and executes an operating system (OS) 101 loaded to the main memory 13 from the storage 18 and various application programs, including a later-described power saving control utility 102, which operates under the control of the OS 101. The OS 101 includes a scheduler 101a for controlling the allocation of tasks (processes or threads) to the CPU 11. The OS 101 and various programs including the power saving control utility 102 are preinstalled in the storage 18.

The host controller 12 is a bridge device for a connection between a local bus of the CPU 11 and the I/O controller 17. The host controller 12 has a function to communicate with the display controller 14 via a bus, and incorporates a memory controller for controlling the access to the main memory 13.

The display controller 14 controls the display device 15 to be operated as a display monitor of the computer 1. The display memory 16 is connected to the display controller 14, and the display controller 14 generates, from image data written into the display memory 16 by the various programs including the OS 101 and the power saving control utility 102, a display signal to be sent to the display device 15.

The I/O controller 17 incorporates a controller for controlling the storage device 18. Moreover, the I/O controller 17 controls the power supply controller 20 (via the EC/KBC 19) and the clock generator 23.

The EC/KBC 19 is a one-chip microcomputer integrating an embedded controller for power management with a keyboard controller for controlling the keyboard 22. The EC/KBC 19 controls the supply of power from the battery 21 or an external AC power source to the respective units, in cooperation with the power supply controller 20. The power supply controller 20 can supply operating power to the CPU 11 in core units. The clock generator 23 for generating the operation clock of the CPU 11 can also supply the operation clock in core units. The supply of the operating power to the CPU 11 by the power supply controller 20 and the supply of the operation clock to the CPU 11 by the clock generator 23 are controlled by operation commands output from the I/O controller 17. That is, in the computer 1, an instruction to output the operation commands is provided to the I/O controller 17 such that the supply of the operating power and the operation clock to the CPU 11 can be controlled.

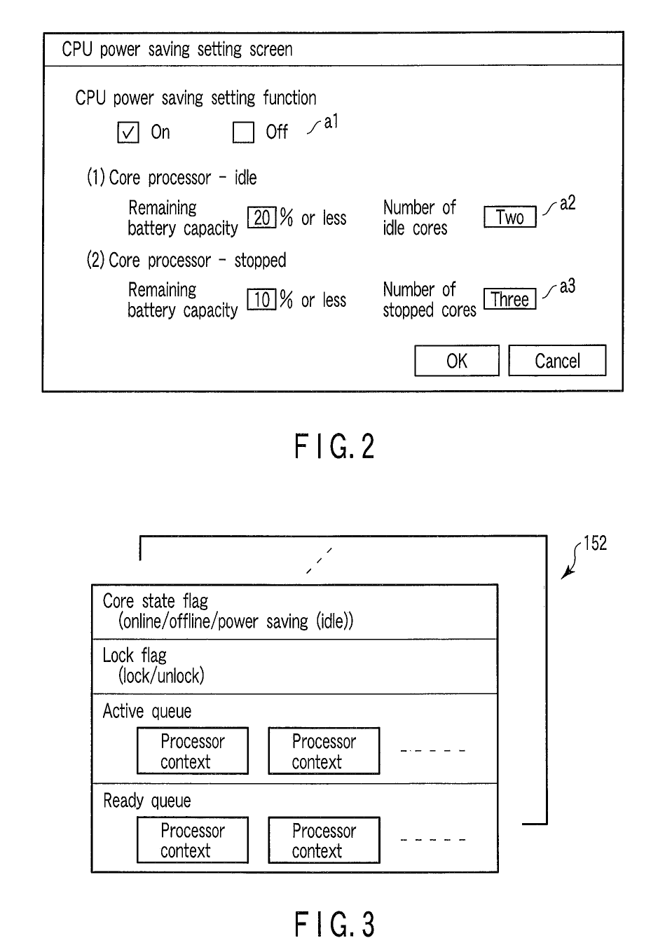

The power saving control utility 102 operating on the computer 1 having such a hardware configuration periodically collects, from the EC/KBC 19, information on whether power is input from the external AC power source and information on the remaining capacity of the battery 21, thereby monitoring the operating power supplying environment in the computer 1. Then, when detecting, for example, a condition where there is no input from the external AC power source, where the computer 1 is operating by the power from the battery 21, and where the remaining capacity of the battery 21 is less than or equal to a preset value, the power saving control utility 102 requests the OS 101 to bring a preset number of cores into an inoperative state (into a power saving mode) As an interface for this purpose, the power saving control utility 102 presents a setting screen, for example, as shown in FIG. 2 to a user.

In this setting screen, the user, firstly, can set whether to validate a power saving function by the power saving control utility 102 (field a1). In the case of validating the function, the user, secondly, can set how many cores to be switched to an idle state when the remaining capacity of the battery 21 is less than or equal to what percent during the operation with the power from the battery 21 (field a2), and can further set how many cores to be switched to a stopped state when the remaining capacity of the battery 21 is less than or equal to what percent (field a3). Each of the idle state and the stopped state is one aspect of the inoperative state, and only one of the settings by the fields a2 and a3 may be provided.

The switch to the idle state substantially reduces power consumption by suppressing the allocation of the tasks to create the idle state while continuing the supply of the operating power by the power supply controller 20 and the supply of the operation clock to by the clock generator 23. The switch to the stopped state essentially shuts off the supply of the operating power by the power supply controller 20 and the supply of the operation clock to by the clock generator 23. The restoration from the idle state or the stopped state is made by the start of the power supply from the external AC power source (whereby the battery 21 can be charged), at which point, if in the idle state, the restoration from this state is made as quickly as possible. In addition, information on these settings is stored in the storage 18 by the power saving control utility 102, and read and placed onto the main memory 13 in accordance with the activation of the power saving control utility 102 (setting information 151).

In the example of FIG. 2, if the remaining capacity of the battery 21 reaches 20% or less during the operation with the power from the battery 21, two cores first switch to the idle state, and if the remaining capacity further reaches 10% or less, three cores switch to the stopped state.

That is, the computer 1 carries out suitable power saving control considering the characteristics of the multicore CPU, for example, controlling the number of operating cores provided in the CPU 11 in accordance with the operating power supplying environment.

Furthermore, in order to enable this power saving control, the scheduler 101a of the OS 101 for receiving the request to switch to the power saving mode from the power saving control utility 102 has a function to reallocate, to the core maintained in the operative state, the tasks already allocated to the cores to be switched to the idle state or the stopped state. After the reallocation of the tasks has been completed, the OS 101 provides the I/O controller 17 with the instruction to output the operation commands to the power supply controller 20 and the clock generator 23 in order to shut off the supply of the operating power and the operation clock to the target core, in the case of the switch to the stopped state.

FIG. 3 is an exemplary diagram showing a configuration of a scheduling queue 152 managed on the main memory 13 by the scheduler 101a of the OS 101 for controlling the allocation of the tasks to the CPU 11.

The scheduling queue 152 is provided per core, that is, one scheduling queue 152 is provided to each of the cores 11a to 11d contained in the CPU 11, and as shown in FIG. 3, the scheduling queue 152 includes a core state flag, a lock flag, an active queue and a ready queue.

The core state flag is a flag to indicate which of the operative state (online), the stopped state (offline) and the idle state (power saving) as the power saving mode each core is in. The scheduler 101a only allocates tasks to the core indicated by the core state flag that this core is in the operative state, that is, queues the tasks (processor contexts) in the active queue or the ready queue.

The lock flag is a flag for exclusively performing access involving the updating of the scheduling queue 152, and indicates one of a locked state and unlocked state. The provision of this lock flag ensures the integrity of the scheduling queue 152.

Furthermore, the active queue is a queue provided to queue the executable tasks, and the ready queue is a queue provided to queue the tasks in a wait state. A task which has been released from the wait state after the occurrence of a particular event is taken from the ready queue and moved to the active queue. The tasks queued in the active queue are selected one by one and allocated to the cores. While there are various techniques for the algorithm of the selection of the tasks such as first-in first-out (FIFO), last-in first-out (LIFO), round robin scheduling and a multistage feedback queue, the power saving control of the computer 1 does not limit which algorithm to be applied by the scheduler 101a.

When a given core switches to the idle state or the stopped state, the scheduler 101a for managing the scheduling queues 152 having the configuration described above and, at the same time, allocating tasks to the CPU 11 moves the tasks queued in the active queue or the ready queue within the scheduling queue 152 of the above-mentioned core to the active queue or the ready queue within the scheduling queue 152 of a core maintained in the operative state. When performing this operation, the scheduler 101a first locks all the scheduling queues 152 using the lock flag.

Next, in the situation where all the scheduling queues 152 are locked, the scheduler 101a moves the tasks among the cores for each of the active queue and the ready queue, and, for example, the following methods are conceived as to which task is moved to which core. Which of these methods to employ is determined as a specification of the computer 1.

(1) The tasks are simply moved to any one of the cores maintained in the operative state. A core is mechanically selected by a predetermined rule without considering, for example, the situations of the cores maintained in the operative state.

(2) The tasks are equally allocated to the cores maintained in the operative state. This allocation may be carried out so that the numbers of simply moved tasks are equal to each other or so that the numbers of tasks in the cores after the completion of the movement are equal to each other.

(3) A core having the smallest number of tasks queued therein at the moment is detected from among the cores maintained in the operative state, and moved.

When the above-mentioned movement of the tasks is completed, the scheduler 101a updates, to a state after the movement, the core state flag within the scheduling queue 152 of the core to be switched, and then unlocks all the scheduling queues 152 using the lock flag. At this point, the OS 101 provides the I/O controller 17 with the instruction to output the operation commands to the power supply controller 20 and the clock generator 23, if necessary.

When the scheduling queue 152 is unlocked, the allocation of the tasks to the CPU 11 by the scheduler 101a is resumed. The tasks already allocated to the cores switched to the idle state or the stopped state are executed in the cores maintained in the operative state. And then, tasks are not allocated to the cores switched to the idle state or the stopped state. That is, suitable power saving control considering the characteristics of the multicore CPU is achieved, for example, controlling the number of operating cores provided in the CPU 11.

Furthermore, as described above, when the power supply from the external AC power source is started, the core which has been in the idle state or the stopped state is restored to the operative state. At this point, the scheduler 101a may only lock the scheduling queue 152 of that core using the lock flag, and update the core state flag to the operative state, and then unlock the scheduling queue 152 again using the lock flag. In addition, the OS 101 provides the I/O controller 17 with the instruction to output the operation commands to the power supply controller 20 and the clock generator 23, if necessary.

However, this case can not be said to be efficient because the restored cores change to the idle state by the next chance of scheduling. Therefore, the scheduler 101a further has a function to, when a given core is restored from the idle state or the stopped state, move the tasks queued in the active queue or the ready queue of the core maintained in the operative state to the active queue or the ready queue of the core restored from the idle state or the stopped state. For example, the following methods are conceived as to taking a task from which core. Which of these methods to employ is determined as a specification of the computer 1.

(1) Half of the tasks are taken from any one of the cores maintained in the operative state. A core is mechanically selected by a predetermined rule without considering, for example, the situations of the cores maintained in the operative state.

(2) The tasks are equally taken from the cores maintained in the operative state. This acquisition may be carried out so that the numbers of simply moved tasks are equal to each other or so that the numbers of tasks in the cores after the completion of the movement are equal to each other.

This makes it possible to improve the efficiency because the restored core switches to the operative state as quickly as possible without waiting for the next chance of scheduling.

And now, in the example of FIG. 2, the OS 101 receives from the power saving control utility 102 a request to switch two cores into the idle state when the remaining capacity of the battery 21 reaches 20% or less during the operation with the power from the battery 21, and the OS 101 further receives from the power saving control utility 102 a request to switch three cores to the stopped state when the remaining capacity reaches 10% or less.

For example, the following methods are conceived as to which core to be switched by the OS 101 to the idle state or the stopped state when receiving the above request. Which of these methods to employ is determined as a specification of the computer 1.

(1) A core with the highest load is selected. In order to carry out efficient power saving (in preference to execution efficiency), it is advisable to select the core with the highest load. Possible definitions of the core with a high load are, for example, (i) a high operating rate and (ii) a large number of queued tasks.

(2) A core which happens to be in the idle state at the moment is selected. In this case, it is possible to minimize the reduction of the execution efficiency.

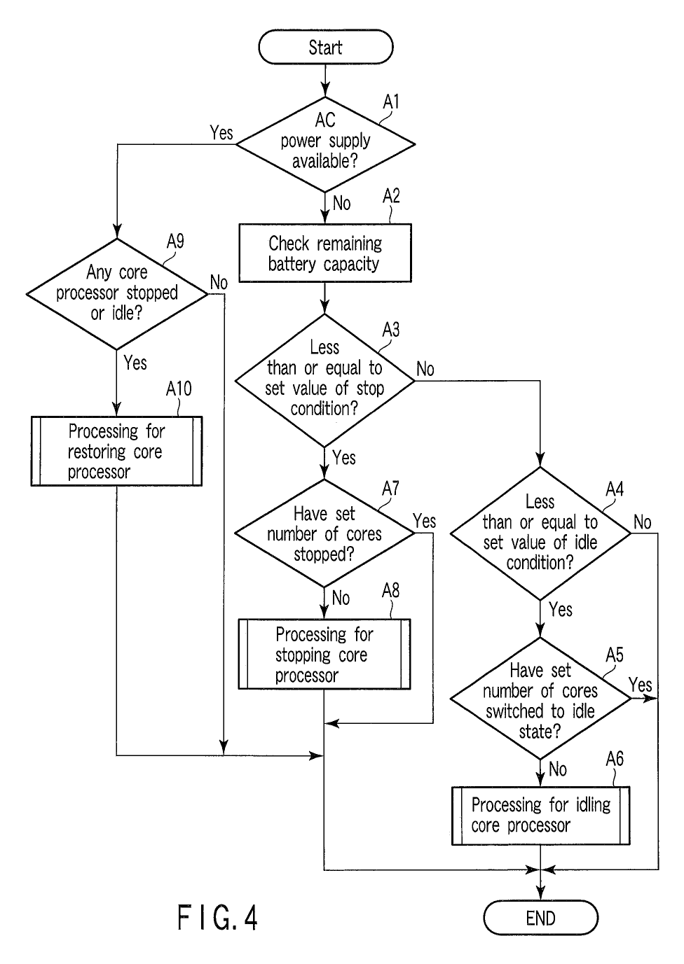

Next, an operation procedure of the power saving control executed by the computer 1 is described referring to FIGS. 4 to 6. FIG. 4 is an exemplary flowchart showing a basic procedure of the power saving control executed by the computer 1.

The power saving control utility 102 checks whether the power is input from the external AC power source on the basis of information collected from the EC/KBC 19 (block A1), and if the power is not input (NO in block A1), the power saving control utility 102 further checks the remaining capacity of the battery 21 again on the basis of the information collected from the EC/KBC 19 (block A2).

At this point, the power saving control utility 102 first judges whether the remaining capacity of the battery is less than or equal to a reference value set as a stop condition (condition set in the field a3 of FIG. 2) (block A3). When the remaining capacity is not less than or equal to the reference value (NO in block A3), the power saving control utility 102 then judges whether the remaining capacity is less than or equal to a reference value set as an idle condition (condition set in the field a2 of FIG. 2) (block A4).

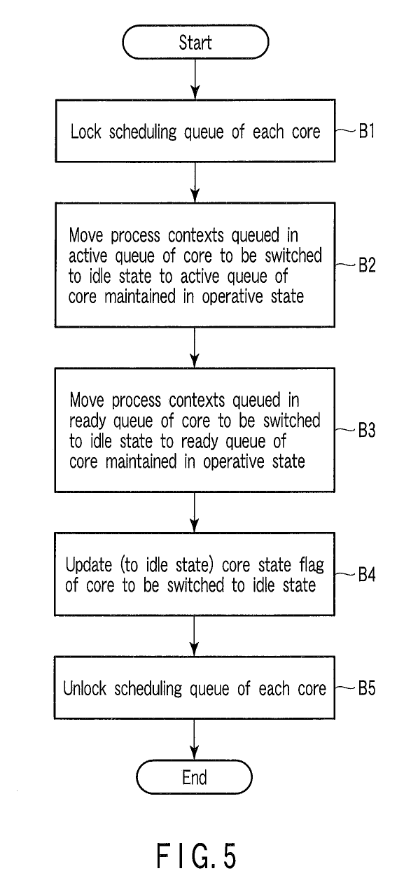

If the remaining capacity is less than or equal to the reference value set as the idle condition (YES in block A4), the power saving control utility 102 checks whether the number of cores set as the idle condition have been switched to the idle state (block A5). If not (NO in block A5), the power saving control utility 102 causes the OS 101 to execute processing for switching any one of the cores to the idle state (block A6). FIG. 5 is an exemplary flowchart showing a detailed procedure in block A6.

The scheduler 101a of the OS 101 first locks the scheduling queue 152 of each core using the lock flag (block B1). After locking, the scheduler 101a moves the tasks queued in the active queue of the core to be switched to the idle state to the active queue of the core maintained in the operative state (block B2), and also moves the tasks queued in the ready queue of the core to be switched to the idle state to the ready queue of the core maintained in the operative state (block B3). As described above, which core to be switched to the idle state and to the queue of which core the tasks already queued in that core are moved are determined as specifications of the computer 1.

After the completion of the movement of the tasks among the cores, the scheduler 101a updates, to the idle state, the core state flag of the core to be switched to the idle state (block B4). Then, the scheduler 101a unlocks the scheduling queue 152 of each core again using the lock flag (block B5).

On the other hand, if the remaining capacity of the battery 21 is less than or equal to the reference value set as the stop condition (YES in block A3), the power saving control utility 102 checks whether the number of cores set as the stop condition have been switched to the stopped state (block A7). If not (NO in block A7), the power saving control utility 102 causes the OS 101 to execute processing for switching any one of the cores to the stopped state (block A8). The procedure in block A8 is substantially similar to that in block A6 described above, and is therefore not described.

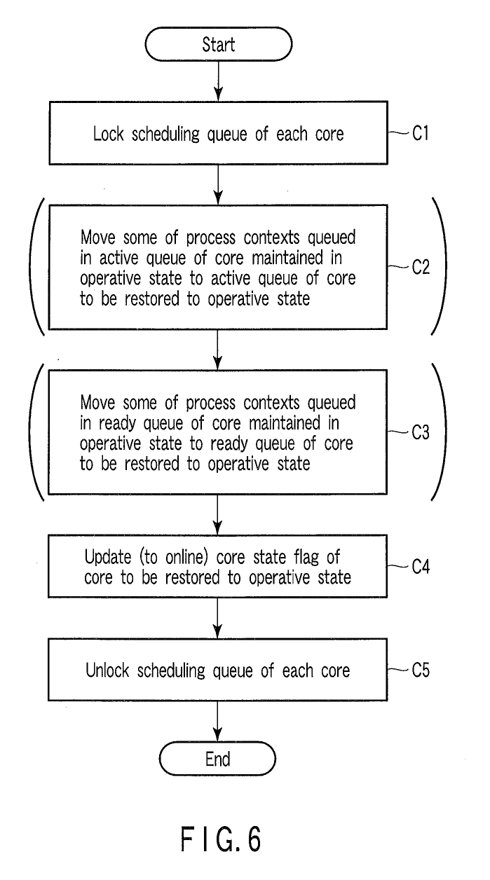

Furthermore, if the power is input from the external AC power source (YES in block A1), the power saving control utility 102 checks whether there is any core in the stopped state or the idle state (block A9). If there is such a core (YES in block A9), the power saving control utility 102 causes the OS 101 to execute processing for restoring the core from the stopped state or the idle state (block A10). FIG. 6 is an exemplary flowchart showing a detailed procedure in block A10.

The scheduler 101a of the OS 101 first locks the scheduling queue 152 of each core using the lock flag (block C1). After locking, the scheduler 101a moves some of the tasks queued in the active queue of the core maintained in the operative state to the active queue of the core to be restored from the stopped state or the idle state (block C2), and also moves some of the tasks queued in the ready queue of the core maintained in the operative state to the ready queue of the core to be restored from the stopped state or the idle state (block C3). The processing in blocks C2, C3 is not indispensable, and as described above, whether to execute blocks C2, C3 and from the queue of which core the tasks are taken (in the case of executing blocks C2, C3) are determined as specifications of the computer 1.

Then, the scheduler 101a updates, to the operative state, the core state flag of the core to be restored from the stopped state or the idle state (block C4), and unlocks the scheduling queue 152 of each core using the lock flag (block C5).

As described above, according to the computer 1, suitable power saving control considering the characteristics of the multicore CPU is achieved, for example, controlling the number of operating cores provided in the CPU 11 in accordance with the operating power supplying environment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a CPU including a plurality of instruction processors;
a monitoring unit configured to monitor an operating power supplying environment; and
a power saving unit configured to control the number of operating instruction processors provided in the CPU in accordance with the operating power supplying environment obtained by the monitoring with the monitoring unit.

2. The information processing apparatus according to claim 1, further comprising a scheduler which controls the allocation of tasks to the CPU,
the scheduler reallocating, to the instruction processor maintained in an operative state, the tasks already allocated to the instruction processor to be switched to an inoperative state, when the number of operating instruction processors decreases by the control of the power saving unit.

3. The information processing apparatus according to claim 2, wherein the scheduler reallocates the tasks already allocated to the instruction processor to be switched to an inoperative state to an instruction processor regularly selected from among the instruction processors maintained in the operative state.

4. The information processing apparatus according to claim 2, wherein the scheduler equally reallocates the tasks already allocated to the instruction processor to be switched to an inoperative state to the instruction processor maintained in the operative state.

5. The information processing apparatus according to claim 2, wherein the scheduler detects an instruction processor having the smallest number of already allocated tasks from among the instruction processors maintained in the operative state, and reallocates, to the detected instruction processor, the tasks already allocated to the instruction processor to be switched to an inoperative state.

6. The information processing apparatus according to claim 2, the scheduler reallocates, to the instruction processor to be restored to the operative state, the tasks already allocated to the instruction processor maintained in the operative state, when the number of operating instruction processors increases by the control of the power saving unit.

7. The information processing apparatus according to claim 6, wherein the scheduler reallocates half of the tasks already allocated to the instruction processor regularly selected from among the instruction processors maintained in the operative state, to an instruction processor to be restored to the operative state.

8. The information processing apparatus according to claim 6, wherein the scheduler equally reallocates the tasks already allocated to the respective instruction processors maintained in the operative state, from these instruction processors to an instruction processor to be restored to the operative state.

9. The information processing apparatus according to claim 1, wherein the power saving unit switches the instruction processors to an inoperative state in descending order of load, when decreasing the number of operating instruction processors.

10. The information processing apparatus according to claim 9, wherein the power saving unit judges an instruction processor with a high operating rate to have a high load.

11. The information processing apparatus according to claim 9, wherein the power saving unit judges an instruction processor with a large number of already allocated tasks to have a high load.

12. The information processing apparatus according to claim 1, wherein the power saving unit switches an instruction processor in an idle state, if any, to an inoperative state, when decreasing the number of operating instruction processors.

13. The information processing apparatus according to claim 1, further comprising a battery,
the power saving unit being supplied operating power from the battery, and decreasing the number of operating instruction processors when a condition where the remaining capacity of the battery is less than or equal to a predetermined capacity is obtained by the monitoring with the monitoring unit.

14. The information processing apparatus according to claim 13, wherein the power saving unit brings a target instruction processor into an idle state to switch the instruction processor to an inoperative state when the remaining capacity of the battery is less than or equal to a first value, and brings the target instruction processor into a stopped state to switch the instruction processor to the inoperative state when the remaining capacity is less than or equal to a second value smaller than the first value.

15. The information processing apparatus according to claim 13, further comprising a setting unit configured to set a remaining capacity of the battery as a condition to decrease the number of operating instruction processors, and to set the number of instruction processors to be switched to an inoperative state.

16. A scheduler applied to an information processing apparatus which is equipped with a CPU including a plurality of instruction processors and which is provided with a function to dynamically change the number of operating instruction processors, the scheduler comprising:
a task reallocating unit configured to reallocate, to the instruction processor maintained in an operative state, tasks already allocated to the instruction processor to be switched to an inoperative state, when the number of operating instruction processors decreases.

17. The scheduler according to claim 16, wherein the task reallocating unit reallocates, to the instruction processor to be restored to the operative state, the tasks already allocated to the instruction processor maintained in the operative state, when the number of operating instruction processors increases.

18. A schedule control method of an information processing apparatus which is equipped with a CPU including a plurality of instruction processors and which is provided with a function to dynamically change the number of operating instruction processors, the schedule control method comprising:
reallocating, to the instruction processor maintained in an operative state, tasks already allocated to the instruction processor to be switched to an inoperative state, when the number of operating instruction processors decreases.

19. The schedule control method according to claim 18, further comprising reallocating, to the instruction processor to be restored to the operative state, the tasks already allocated to the instruction processor maintained in the operative state, when the number of operating instruction processors increases.
